(19) United States
(12) Patent Application Publication
(10) Pub. No.: US 2012/0105332 A1
(43) Pub. Date: May 3, 2012

(54) SURFACE COMPUTING DEVICE

(75) Inventors: Curt Aumiller, Redmond, WA (US); August Valentin Isabelo de los Reyes, Bellevue, WA (US); David Hudson Titzler, Palo Alto, CA (US); Mohammed Nadir Haq, Seattle, WA (US); Bernie Schultz, Bothell, WA (US); Rajesh Manohar Dighde, Redmond, WA (US)

(73) Assignee: MICROSOFT CORPORATION, Redmond, WA (US)

(21) Appl. No.: 12/913,490

(22) Filed: Oct. 27, 2010

(51) Int. Cl. G06F 3/041

(52) U.S. Cl. 345/173

(57) ABSTRACT

A surface computing device including a display engine configured to selectively display images on a display surface, and a touch-detection engine configured to detect touch inputs directed to the display surface is provided. The surface computing device includes a front face with the display surface that is relatively larger than the rear face. The surface computing device further includes a beveled edge between the front face and the rear face.

### BACKGROUND

Advances in computing systems have led to corresponding advances in the ways in which human users interact with computing systems. In particular, the input devices with which a user controls the computing system have improved. Some computing systems utilize keyboards to receive typed computing commands that are executed by the computing system. Some computing systems utilize mice, trackballs, track pads, and/or other pointer devices for controlling a graphical user interface. Some computing systems utilize touch screens that allow users to more directly control a graphical user interface by physically touching the screen displaying the graphical elements of the user interface. Improvements in input devices can help new computer users quickly learn how to operate a computing system while also improving the user experience of more advanced users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A surface computing device includes a display engine configured to selectively display images on a display surface, and a touch-detection engine configured to detect touch inputs directed to the display surface. The surface computing device includes a front face with the display surface that is relatively larger than the rear face. The surface computing device further includes a beveled edge between the front face and the rear face.

### BRIEF DESCRIPTION OF THE DRAWINGS

FIG. 1 shows an example surface computing device in accordance with embodiments of the present disclosure.

FIG. 2 shows a front face of the example surface computing device of FIG. 1.

FIG. 3 shows another view of the example surface computing device of FIG. 1.

FIG. 4 shows a portion of an example surface computing device having a coplanar display surface and frame.

FIG. 5 shows a portion of an example surface computing device having a recessed display surface relative to the frame.

FIG. 6 schematically shows the example surface computing device of FIG. 1.

### DETAILED DESCRIPTION

The present disclosure is directed to surface computing devices that serve as both a display and a touch input device. As a display, a surface computing device in accordance with the present disclosure is capable of visually presenting images, including, but not limited to, user interfaces, application interfaces, visual media, television programming, and the like. As a touch input device, the surface computing device is able to detect user touches directed to a display surface of the surface computing device. Such user touches can be interpreted as user input commands, which can be used to control various aspects of the surface computing device and/or various programs running on the surface computing device.

Surface computing devices may utilize a variety of different technologies for visually presenting images and/or detecting touch inputs. Surface computing devices in accordance with the present disclosure are not limited to any particular technologies. As nonlimiting examples, display images may be presented by liquid crystal display panels, plasma display panels, light emitting diode display panels, rear projection displays, including rear projection displays that utilize a wedge-shaped light guide, or virtually any other display technology. Any suitable touch-detection technology that is compatible with the chosen display technology may be used. For example, embodiments that employ a rear projection display technology may use a vision-based touch detection technology in which one or more infrared cameras are used to detect infrared reference light that is reflected from a user's finger touching the display surface. As another example, embodiments that use a liquid crystal display panel may include a capacitive array to detect user touches directed at the display surface. These and other suitable technologies are within the scope of this disclosure.

In some embodiments, a surface computing device is configured to be used with a horizontal orientation. When orientated horizontally, a surface computing device may accommodate use by two or more different users, who can gather around the surface computing device in much the same way as people can gather around a table. In this configuration, two or more users can easily touch the display surface and control various aspects of the surface computing device and/or programs running on the surface computing device.

Many obstacles can serve as a barrier to a first-time user presented with an opportunity to interact with and control a horizontally-orientated surface computing device. As one example, some users are hesitant to treat a surface computing device as a conventional table and are reluctant to place beverages, personal items, or other objects on the surface computing device. This can deter from a user's experience with the surface computing device.

As an example of another obstacle, the appearance of the surface computing device can deter a user from comfortably using the device. It is believed that surface computing devices that appear big and bulky are less likely to be used comfortably, if at all. In particular, it is believed that an untrained user is more likely to use a surface computing device as if the surface computing device were a conventional table if the surface computing device appears to have a thin tabletop, similar to a conventional table. This initial enticement to use the surface computing device can lead to further user exploration and more advanced usage of the surface computing device.

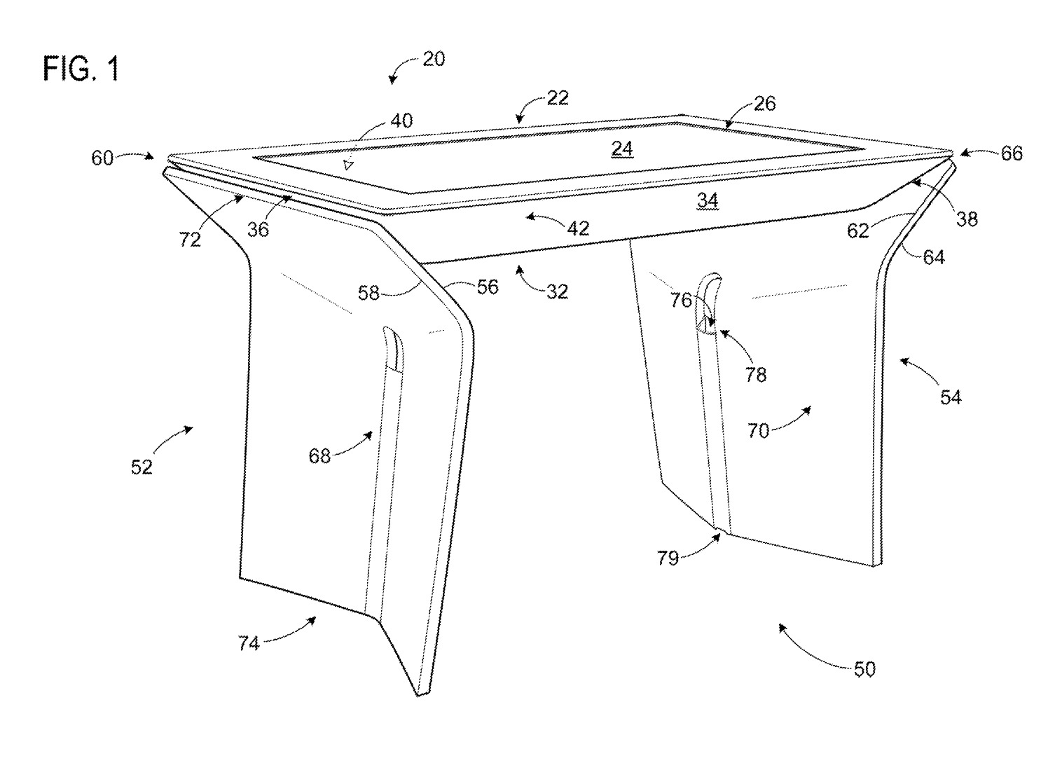

FIG. 1 shows an example surface computing device 20 in accordance with an embodiment of the present disclosure. Surface computing device 20 includes a front face 22 including a display surface 24 configured to display images. Surface computing device 20 may be configured to display images on display surface 24 in any suitable way. For example, surface computing device 20 may include a display engine configured to selectively display images on display surface 24. The display engine may utilize any suitable technologies to visually present images as described above, including but not limited to a liquid crystal display panel, a plasma display panel, a light emitting diode display panel, a rear projection display, including a rear projection display that utilizes a wedge-shaped light guide, or virtually any other display technology. Surface computing device 20 may further include a touch-detection engine configured to detect touch inputs directed to display surface 24. In this way, surface computing device 20 serves as both a display and an interactive touch input device. The touch-detection engine may utilize any suitable technologies compatible with the chosen display technology. As described above, such technologies include but are not limited to a vision-based touch detection technology, a capacitive array to detect user touches directed at the display surface, etc.

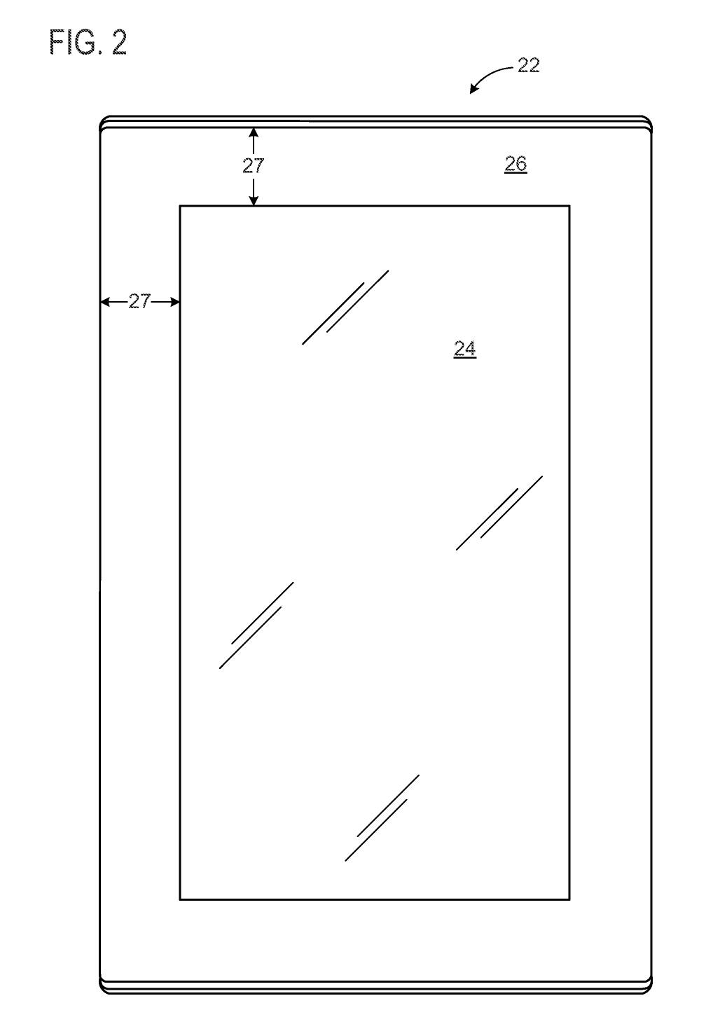

Front face 22 further includes a frame 26 surrounding display surface 24 and parallel to display surface 24, as shown in FIGS. 1 and 2. Frame 26 may provide functional as well as aesthetic enhancements to the user experience. With regard to the former, frame 26 may be configured to support objects set on frame 26 without obstructing display surface 24. As briefly introduced above, when using horizontal interactive displays, users desire to set personal items down on the display surface (e.g., glassware, a wallet, a phone, etc.) so that their hands are free for interaction. Thus, frame 26 may provide such an area for personal objects. With regard to the latter, frame 26 may enhance a beveled perception of surface computing device 20. Whereas a lack of a border enhances the illusion of a tall wall (e.g., the reveal of surface computing device 20 from a side view appears thick), frame 26 allows for a more unobstructed line-of-sight of the user (e.g., a seated user). In this way, surface computing device 20 appears to have a thinner form factor. As such, a user may be more likely to approach surface computing device 20 as it may look more familiar, like a table, as opposed to a daunting, massive device.

Frame 26 may have any suitable shape. In some embodiments, front face 22 and display surface 24 may be substantially rectangular, as depicted in FIGS. 1 and 2. As such, frame 26 surrounding display surface 24 may be a substantially-rectangular frame which maintains a width 27 around the entirety of display surface 24, as shown in FIG. 2. Frame 26 may have any suitable width 27. Examples of suitable widths include but are not limited to at least 3 inches, and at least 4 inches.

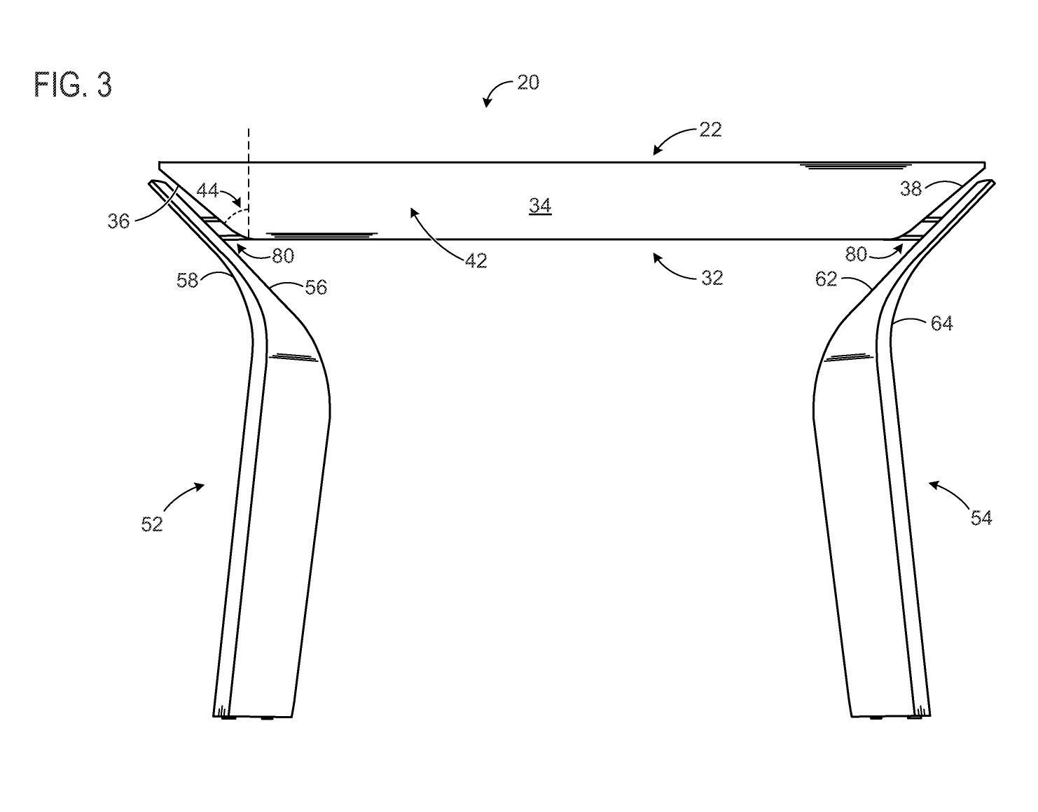

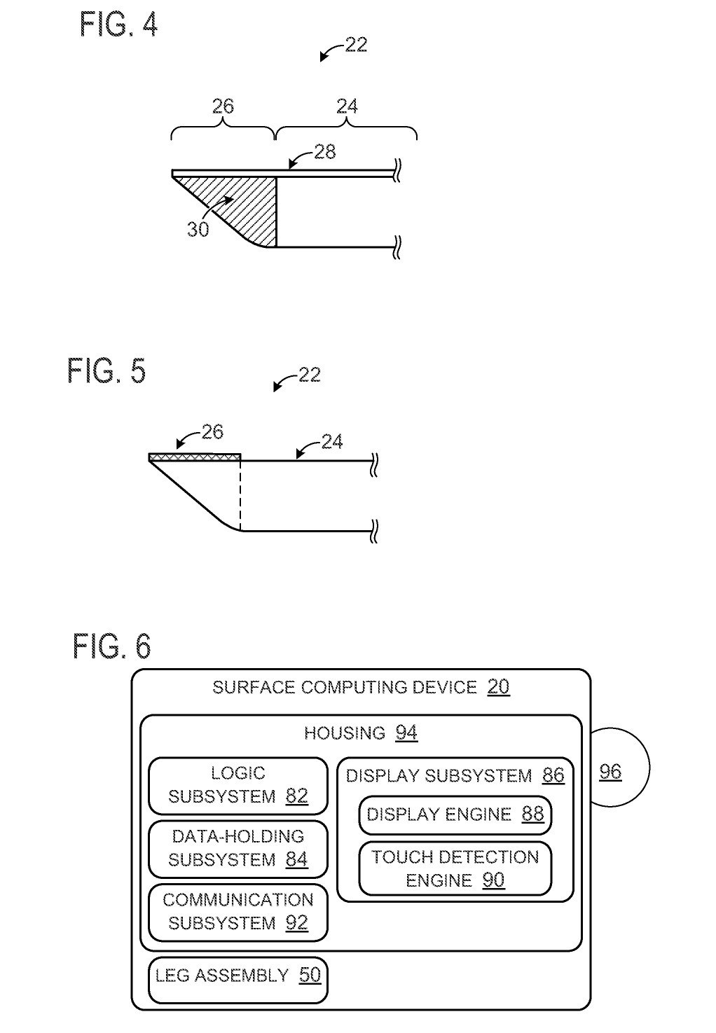

Further, frame 26 may be positioned in any suitable configuration. As described above, frame 26 may surround display surface 24 and be parallel to display surface 24. As such, in some embodiments, display surface 24 and frame 26 may be coplanar, as shown in FIGS. 3 and 4. Further, in such embodiments, display surface 24 and frame 26 may share a single transparent panel 28, as shown in FIG. 4. Transparent panel 28 may include, for example, a bezel-less seamless piece of glass, to further enhance the visual perception of a thinner form factor. Frame 26 may further include an opaque frame member 30 under the single transparent panel 28. It should be appreciated that opaque frame member 30 may be any suitable shape, and FIG. 4 is not intended to be limiting in any way.

Alternative to a planar configuration, in other embodiments, display surface 24 may be recessed relative to frame 26, as shown in FIG. 5. It should be appreciated that display surface 24 may be recessed relative to frame 26 in any suitable way and/or recessed by any suitable magnitude, and thus FIG. 5 is not intended to be limiting in any way.

Continuing with FIG. 1, surface computing device 20 further includes a rear face 32 opposite front face 22. Rear face 32 may be any suitable shape and/or size. For example, in some embodiments, the rear face may be substantially rectangular. In some embodiments, rear face 32 may be sized such that a planar projection of rear face 32 onto a plane of display surface 24 is smaller than a planar projection of front face 22 onto the plane of display surface 24. However, in other embodiments, the planar projection of rear face 32 onto the plane of display surface 24 may be sized substantially the same as display surface 24.

Continuing with FIG. 1, surface computing device 20 further comprises a beveled edge 34 between front face 22 and rear face 32. Beveled edge 34 may be beveled inward relative to a normal to display surface 24, so as to give the illusion of less depth, further enhancing the visual perception of a thinner form factor.

Beveled edge 34 may include multiple beveled edge segments, such as a first edge segment 36 opposing a second edge segment 38 on opposite sides of front face 22 and opposite sides of rear face 32. Beveled edge 34 may further include a third edge segment 40 opposing a fourth edge segment 42 on opposite sides of front face 22 and opposite sides of rear face 32, as illustrated in FIG. 1. More specifically, second edge segment 38 may oppose first edge segment 36, and third edge segment 40 may be between first edge segment 36 and second edge segment 38. Further, fourth edge segment 42 may oppose third edge segment 40 and be between first edge segment 36 and second edge segment 38.

Each beveled edge segment may be angled relative to a normal of display surface 24 at any suitable angle. In some embodiments, each beveled edge segment may be angled 40 degrees or more relative to a normal to display surface 24, as depicted in FIG. 3 at 44.

Surface computing device 20 may be mounted in any suitable manner, for example, based on the use environment and/or a user's ergonomic and/or accessibility needs. As such, in some embodiments, surface computing device 20 may be wall-mounted, for example, using a Video Electronics Standards Association (VESA) mount.

However, in some embodiments, surface computing device 20 may further include a leg assembly 50. Leg assembly 50 may be configured to hold front face 22 at any suitable orientation. For example, in some embodiments, leg assembly 50 may be configured to hold front face 22 in a substantially horizontal orientation above a support surface, such as the floor. However, it should be appreciated that such an orientation is nonlimiting, and in other embodiments, the leg assembly may hold the front face at any other desired orientation, such as at an angle with respect to the support surface.

In some embodiments, leg assembly 50 may be mounted to beveled edge 34. Such mounting may be done in any suitable way, so as to provide optionality and flexibility based on the use environment (e.g., commercial, educational, public, etc.). For example, the leg assembly may provide for a horizontal table-like orientation, as described above, at any suitable height. For example, a surface computing system in a public-use environment may be at a height appropriate for standing users, or seated users, whereas a surface computing system in a home-use environment may be substantially lower, such as at a standard coffee-table height. As another example, the leg assembly may be mounted so as to provide a tilted display surface 24, such as that suitable for a public kiosk. Further yet, in addition to providing optionality and flexibility based on the use environment, the leg assembly may provide flexibility from a user-standpoint, for ergonomic purposes, or to comply with accessibility standards of the Americans with Disabilities Act (ADA). Further, in some embodiments, leg assembly 50 may be mounted to beveled edge 34 via VESA mounts.

Leg assembly 50 may include a first leg unit 52 and a second leg unit 54. Leg assembly 50 may be mounted to beveled edge 34 such that the leg units are at opposite sides of front face 22 and rear face 32. For example, first leg unit 52 may be mounted to first edge segment 36 of beveled edge 34, and second leg unit 54 may be mounted to second edge segment 38 of beveled edge 34. However, it should be appreciated that this example is nonlimiting.

Further, each leg unit may include an inner face and an outer face. For example, first leg unit 52 may include an inner face 56 and an outer face 58. As such, first leg unit 52 may be mounted to first edge segment 36 of beveled edge 34 such that inner face 56 is spaced away from beveled edge 34, as shown in FIG. 1 at 60. Likewise, second leg unit 54 may include an inner face 62 and an outer face 64. In such a case, second leg unit 54 may be mounted to second edge segment 38 of beveled edge 34 such that inner face 62 is spaced away from beveled edge 34, as shown at 66.

Such spaced-away mounting, in combination with frame 26 and beveled edge 34, further promotes the illusion of a floating display that has thinner form factor. Further, in addition to aesthetics, such a reveal between the leg assembly and housing allows for a wider tolerance range in manufacturing processes.

Further, each leg unit may include a shaped panel, such as shaped panel 68 of first leg unit 52, and shaped panel 70 of second leg unit 54. It should be appreciated that a shaped panel may have any suitable shape. For example, a shaped panel having an endview with a slight taper from top to bottom may provide users with more toe clearance yet may still maintain a wide base for stability. As another example, the shaped panel may allow for kneeling users to have a natural clearance. As yet another example, a form-fitting shaped panel may allow users to interact with surface computing device 20 without stress on the lower back. As yet another example, a shaped panel (e.g., shaped panel 68 of first leg unit 52) may include a straight top edge (e.g., straight top edge 72) proximate to front face 22 and a non-straight bottom edge (e.g., non-straight bottom edge 74) proximate to the support surface, such as the floor.

Further, one or more of the shaped panels may include an interior channel configured to hide cords. FIG. 1 illustrates an example interior channel 76 included within shaped panel 70 of second leg unit 54. Such integrated cable routing and management may allow for more flexible input/output options.

In some embodiments, the shaped panel may further include an inner face mounted to beveled edge 34 and an outer face facing away from beveled edge 34. Such inner and outer faces may serve as the faces of the leg unit. The interior channel may then be positioned within the shaped panel, for example, between the inner face and outer face. As such, an inner face of a shaped panel may include an aperture opening to an upper portion of the interior channel. Thus, for the case of interior channel 76 included within shaped panel 70 of second leg unit 54, inner face 62 may further include an aperture opening 78 to an upper portion of interior channel 76. Aperture opening 78 may be utilized, for example, for receiving cords directed into interior channel 76. In this way, the cords are hidden from view within the shaped panel of the leg assembly, providing a more aesthetically pleasing surface computing device and more flexible input/output options. In some embodiments, the cords may then exit interior channel 76 at a notched region of the non-straight bottom edge of shaped panel 70, as indicated at 79.

It should be appreciated that surface computing device 20 may include additional or alternative features. For example, surface computing device 20 may further include a groove about a perimeter of a portion of front face 22 for concealing ventilation regions or perforation, and/or providing an access door for servicing surface computing device 20. Further, surface computing device 20 may include mounting assemblies 80 as shown in FIG. 3 which maintain the spaced-apart mounting. In some embodiments, mounting assemblies 80 may include VESA mounts.

FIG. 6 schematically shows surface computing device 20. Surface computing device 20 includes logic subsystem 82, data-holding subsystem 84, a display subsystem 86 comprising a display engine 88 and touch-detection engine 90, communication subsystem 92, housing 94, leg assembly 50, and/or other components not shown in FIG. 6. Surface computing device 20 may also optionally include auxiliary user input devices such as keyboards, mice, game controllers, cameras, and/or microphones, for example.

Logic subsystem 82 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 84 may include one or more physical, non-transitory, devices configured to hold data and/or instructions executable by the logic subsystem to implement the herein described methods and processes. When such methods and processes are implemented, the state of data-holding subsystem 84 may be transformed (e.g., to hold different data).

Data-holding subsystem 84 may include removable media and/or built-in devices. Data-holding subsystem 84 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 84 may include devices with one or more of the following characteristics: volatile, nonvolatile, dynamic, static, read/write, read-only, random access, sequential access, location addressable, file addressable, and content addressable. In some embodiments, logic subsystem 82 and data-holding subsystem 84 may be integrated into one or more common devices, such as an application specific integrated circuit or a system on a chip.

FIG. 6 also shows an aspect of the data-holding subsystem in the form of removable computer-readable storage media 96, which may be used to store and/or transfer data and/or instructions executable to implement the herein described methods and processes. Removable computer-readable storage media 96 may take the form of CDs, DVDs, HD-DVDs, Blu-Ray Discs, EEPROMs, and/or floppy disks, among others.

The terms “module,” “program,” and “engine” may be used to describe an aspect of surface computing device 20 that is implemented to perform one or more particular functions. In some cases, such a module, program, or engine may be instantiated via logic subsystem 82 executing instructions held by data-holding subsystem 84. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

Display engine 88 may be configured to display images in any suitable way. As nonlimiting examples, display images may be presented by a liquid crystal display panel, a plasma display panel, a light emitting diode display panel, a rear projection display, including a rear projection display that utilizes a wedge-shaped light guide, or virtually any other display technology.

Touch-detection engine 90 may utilize any suitable touch-detection technology that is compatible with the chosen display technology. As nonlimiting examples, touch inputs may be detected by vision-based touch detection technology, a capacitive array to detect user touches directed at the display surface, resistive touch detection technologies, etc. Further, touch-detection engine 90 may be configured to detect any suitable input touches, including single touches, multi-touches, touch-gestures, and the like.

It should be appreciated that housing 94 of surface computing device 20 and/or leg assembly 50 are not intended to be limiting in any way. The housing may be configured in other shapes, sizes, etc. and may be made of different materials without departing from the scope of this disclosure. Further, the leg assembly may include leg units of different heights, shapes, materials, configurations, etc. and/or a different number of leg units and/or different mounting points, etc.

Communication subsystem 92 may be configured to communicatively couple surface computing device 20 with one or more other computing devices. Communication subsystem 92 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow surface computing device 20 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A surface computing device, comprising:
a front face, including:
a display surface, and
a frame surrounding and parallel to the display surface;
a rear face, opposite the front face, the rear face sized such that a planar projection of the rear face onto a plane of the display surface is smaller than a planar projection of the front face onto the plane of the display surface;
a beveled edge between the front face and the rear face;
a display engine configured to selectively display images on the display surface; and
a touch-detection engine configured to detect touch inputs directed to the display surface.

2. The surface computing device of claim 1, further comprising a leg assembly configured to hold the front face in a substantially horizontal orientation above a support surface.

3. The surface computing device of claim 2, where the leg assembly is mounted to the beveled edge.

4. The surface computing device of claim 2, where the beveled edge includes a first edge opposing a second edge on opposite sides of the front face and opposite sides of the rear face, and a third edge opposing a fourth edge on opposite sides of the front face and opposite sides of the rear face, and where the leg assembly includes a first leg unit mounted to the first edge and a second leg unit mounted to the second edge.

5. The surface computing device of claim 4, where the first leg unit includes an inner face, and wherein the first leg unit is mounted to the first edge of the beveled edge such that the inner face is spaced away from the beveled edge.

6. The surface computing device of claim 4, where each of the first leg unit and the second leg unit includes a shaped panel including a straight top edge proximate to the front face and a non-straight bottom edge proximate to the support surface.

7. The surface computing device of claim 6, where the shaped panel of at least the first leg unit includes an interior channel configured to hide cords.

8. The surface computing device of claim 7, where the shaped panel includes an inner face mounted to the beveled edge and an outer face facing away from the beveled edge, and where the inner face includes an aperture opening to an upper portion of the interior channel.

9. The surface computing device of claim 1, where the planar projection of the rear face onto the plane of the display surface is sized substantially the same as the display surface.

10. The surface computing device of claim 1, where the display surface is recessed relative to the frame.

11. The surface computing device of claim 1, where the display surface and the frame are coplanar.

12. The surface computing device of claim 11, where the display surface and the frame share a single transparent panel, and where the frame further includes an opaque frame member under the single transparent panel.

13. The surface computing device of claim 1, where the frame is at least 3 inches wide around an entirety of the display surface.

14. The surface computing device of claim 1, where the frame is at least 4 inches wide around an entirety of the display surface.

15. A surface computing device, comprising:
a front face, including:
a display surface, and
a frame surrounding and parallel to the display surface, the frame configured to support objects set on the frame without obstructing the display surface;
a leg assembly configured to hold the front face in a substantially horizontal orientation above a support surface;
a display engine configured to selectively display images on the display surface; and
a touch-detection engine configured to detect touch inputs directed to the display surface.

16. The surface computing device of claim 15, further comprising
a beveled edge, the beveled edge including:
a first beveled edge segment, the first beveled edge segment angled 40 degrees or more relative to a normal to the display surface,
a second beveled edge segment opposing the first beveled edge segment, the second beveled edge segment angled 40 degrees or more relative to the normal to the display surface,
a third beveled edge segment between the first beveled edge segment and the second beveled edge segment, the third beveled edge segment angled 40 degrees or more relative to the normal to the display surface, and
a fourth beveled edge segment opposing the third beveled edge segment and between the first beveled edge segment and the second beveled edge segment, the fourth beveled edge segment angled 40 degrees or more relative to the normal to the display surface.

17. The surface computing device of claim 16, where the frame is at least 3 inches wide around an entirety of the display surface.

18. The surface computing device of claim 16, where the frame is at least 4 inches wide around an entirety of the display surface.

19. A surface computing device, comprising:
a substantially rectangular front face, including a substantially rectangular display surface, and
a substantially rectangular rear face, opposite the substantially rectangular front face;
a beveled edge, including:
a first beveled edge segment, the first beveled edge segment angled 40 degrees or more relative to a normal to the substantially rectangular display surface,
a second beveled edge segment opposing the first beveled edge segment, the second beveled edge segment angled 40 degrees or more relative to the normal to the substantially rectangular display surface,
a third beveled edge segment between the first beveled edge segment and the second beveled edge segment, the third beveled edge segment angled 40 degrees or more relative to the normal to the substantially rectangular display surface, and
a fourth beveled edge segment opposing the third beveled edge segment and between the first beveled edge segment and the second beveled edge segment, the fourth beveled edge segment angled 40 degrees or more relative to the normal to the substantially rectangular display surface;
a leg assembly configured to hold the substantially rectangular front face in a substantially horizontal orientation above a support surface, the leg assembly including:
a first leg unit mounted to the first beveled edge segment, and
a second leg unit mounted to the second beveled edge segment;
a display engine configured to selectively display images on the substantially rectangular display surface; and
a touch-detection engine configured to detect touch inputs directed to the substantially rectangular display surface.

20. The surface computing device of claim 19, where the substantially rectangular front face further includes a substantially rectangular frame surrounding and parallel to the substantially rectangular display surface, the substantially rectangular frame being at least 4 inches wide around an entirety of the substantially rectangular display surface.
